(19) United States
(12) Patent Application Publication
(10) Pub. No.: US 2025/0238556 A1
(43) Pub. Date: Jul. 24, 2025

(54) SYSTEM AND METHOD FOR CONNECTING MERCHANDISE-EMBEDDED CHIPS TO CUSTOMIZABLE BRAND APPLICATIONS

(71) Applicant: Dopamine World, Inc., Los Angeles, CA (US)

(72) Inventors: Leeren Chang, Los Angeles, CA (US); Janice Nam, Los Angeles, CA (US)

(73) Assignee: Dopamine World, Inc., Los Angeles, CA (US)

(21) Appl. No.: 18/766,809

(22) Filed: Jul. 9, 2024

Related U.S. Application Data
(60) Provisional application No. 63/624,531, filed on Jan. 24, 2024.

(51) Int. Cl. G06F 21/73; H04L 9/30

(52) U.S. Cl. CPC G06F 21/73; H04L 9/3073

(57) ABSTRACT

A system for binding merchandise to a third-party application includes a registration computer system, wherein the registration computer system is structured and configured to create or receive a unique digital identity for an integrated circuit (IC) chip, wherein the IC chip has wireless communication capability, wherein the unique digital identity is or will be stored in the IC chip and wherein the IC chip is or will be embedded as part of a physical product, and cause information for the IC chip and the physical product to be created and communicated to a system registry for storage in the system registry, wherein the information includes: (i) the unique digital identity, (ii) an identifier of the third-party application, (iii) product metadata for the physical product, and (iv) owner information indicative of a current owner of the physical product.

### CROSS REFERENCE TO RELATED APPLICATIONS

This application claims priority to U.S. Provisional Patent Application Ser. No. 63/624,531, filed on Jan. 24, 2024 and titled “System for Connecting Merchandise-Embedded NFC Chips to Customizable Brand Applications,” the disclosure of which is incorporated herein by reference.

### FIELD OF THE INVENTION

The disclosed concept relates generally to the enhancement of brand-to-consumer experiences, and, in particular, to a system and method for connecting merchandise embedded chips, such as near field communication (NFC) chips, to customizable brand applications by way of a brand registry, such as a centralized registry, a decentralized blockchain registry, or a combination of the two, which stores unique, publicly verifiable digital representations of the embedded chips.

### BACKGROUND OF THE INVENTION

For certain products, such as, without limitation, collectibles or other limited edition products, it can be important to be able to accurately identify and authenticate the product and/or the owner of the product. Current systems, such a digital systems including brand-specific applications, for providing such authentication have several limitations and drawbacks. For example, current systems are lacking in at least the following areas: (i) physical blockchain-based product authentication, (ii) digital asset ownership tied to physical goods, and (iii) secure transfers of physical products. There is thus a need for a system and methodology that addresses these limitations and drawbacks.

### SUMMARY OF THE INVENTION

In one embodiment, a registration method for binding merchandise to a third-party application is provided that includes creating or receiving a unique digital identity for an integrated circuit (IC) chip, wherein the IC chip has wireless communication capability, wherein the unique digital identity is or will be stored in the IC chip and wherein the IC chip is or will be embedded as part of a physical product, and causing information for the IC chip and the physical product to be created and communicated to a system registry for storage in the system registry. The information includes: (i) the unique digital identity, (ii) an identifier of the third-party application, (iii) product metadata for the physical product, and (iv) owner information indicative of a current owner of the physical product.

In another embodiment, a system for binding merchandise to a third-party application is provided that includes a registration computer system, wherein the registration computer system is structured and configured to create or receive a unique digital identity for an integrated circuit (IC) chip, wherein the IC chip has wireless communication capability, wherein the unique digital identity is or will be stored in the IC chip and wherein the IC chip is or will be embedded as part of a physical product, and cause information for the IC chip and the physical product to be created and communicated to a system registry for storage in the system registry, wherein the information includes: (i) the unique digital identity, (ii) an identifier of the third-party application, (iii) product metadata for the physical product, and (iv) owner information indicative of a current owner of the physical product.

In yet another embodiment, a method of validating an integrated circuit (IC) chip embedded as part of a physical product is provided, wherein the IC chip and the physical product are bound to a third-party application in a system registry, wherein the system registry stores information for the IC chip that includes a unique digital identity for the IC chip and an identifier of the third-party application. The method includes receiving validation data generated by the IC chip from a computing device, wherein the validation data includes first information associated with the unique digital identity, receiving second information associated with the unique digital identity, determining whether the IC chip can be validated based on the validation data and the second information associated with the unique digital identity, and responsive to determining that the IC chip can be validated, communicating the identifier of the third-party application to the computing device.

In still another embodiment, a system for validating an integrated circuit (IC) chip embedded as part of a physical product is provided, wherein the IC chip and the physical product are bound to a third-party application in a system registry, wherein the system registry stores information for the IC chip that includes a unique digital identity for the IC chip and an identifier of the third-party application. The system includes a computer system, wherein the computer system is structured and configured to: receive validation data generated by the IC chip from a computing device, wherein the validation data includes first information associated with the unique digital identity, receive second information associated with the unique digital identity, determine whether the IC chip can be validated based on the validation data and the second information associated with the unique digital identity, and responsive to determining that the IC chip can be validated, communicate the identifier of the third-party application to the computing device.

In another embodiment, a method of controlling digital ownership of a physical product and an integrated circuit (IC) chip embedded as part of the physical product is provided, wherein the IC chip and the physical product are bound to a third-party application in a system registry, wherein the system registry stores information for the IC chip that includes a unique digital identity for the IC chip, an identifier of the third-party application, and owner information indicative of a current owner of the IC chip and the physical product. The method includes determining whether a user desiring to obtain ownership of the physical product and the IC chip can be authenticated based on user account credentials provided by the user, receiving an ownership claim from a user for the physical product and the IC chip, and responsive to the ownership claim and determining that the user can be authenticated, causing the owner information stored in the system registry to indicate that the user is the current owner of the IC chip and the physical product.

In another embodiment, a system for controlling digital ownership of a physical product and an integrated circuit (IC) chip embedded as part of the physical product is provided, wherein the IC chip and the physical product are bound to a third-party application in a system registry, wherein the system registry stores information for the IC chip that includes a unique digital identity for the IC chip, an identifier of the third-party application, and owner information indicative of a current owner of the IC chip and the physical product. The system includes a computer system, wherein the computer system is structured and configured to determine whether a user desiring to obtain ownership of the physical product and the IC chip can be authenticated based on user account credentials provided by the user, receive an ownership claim from a user for the physical product and the IC chip, and responsive to the ownership claim and determining that the user can be authenticated, cause the owner information stored in the system registry to indicate that the user is the current owner of the IC chip and the physical product.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a system for connecting merchandise embedded chips to customizable brand applications by way of a brand registry according to a non-limiting exemplary embodiment of the disclosed concept;

FIG. 2 is a schematic diagram which illustrates the registration process for AS chips in the system of FIG. 1 according to an exemplary embodiment of the disclosed concept;

FIG. 3 is a schematic diagram which illustrates the information that is stored in each AS chip and which is stored as a record in the system registry of FIG. 1 during the registration process according to an exemplary embodiment of the disclosed concept;

FIG. 4 is a schematic diagram which illustrates the registration process for SS chips in the system of FIG. 1 according to an exemplary embodiment of the disclosed concept;

FIG. 5 is a schematic diagram which illustrates the information that is stored in each SS chip and which is stored as a record in the system registry of FIG. 1 during the registration process according to an exemplary embodiment of the disclosed concept;

FIG. 6 is a schematic diagram which illustrates the process for validating a product and embedded AS chip according to an exemplary embodiment of the disclosed concept;

FIG. 7 is a schematic diagram which illustrates the process for validating a product and embedded SS chip according to an exemplary embodiment of the disclosed concept;

FIGS. 8 and 9 are exemplary webpages illustrating the ownership claiming functionality of the system of FIG. 1 according to an exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the disclosed concept. It will be evident, however, that the disclosed concept can be practiced without these specific details without departing from the spirit and scope of this innovation.

As described in detail herein, the disclosed concept provides a system wherein wireless communication capable integrated circuit (IC) chips, such as near field communication (NFC) chips, are embedded in merchandise, such as, without limitation, clothing, handbags or other physical products, and wherein the chip, and specifically a unique public key of the chip, is bound to a third-party application, for example by way of a uniform resource locator (URL) or other identifier for the application, that is not widely available (e.g., the URL is not a public URL), through a system registry that may be a centralized registry, a decentralized registry, or a combination of a centralized registry and decentralized registry. As described herein, to implement such a registry, the system may employ a normal backend centralized server and database system, a decentralized blockchain registry, or a combination of the two. More specifically, the centralized server and/or decentralized blockchain registry comprises a system registry that maintains a list of records for each chip, and thus each item of merchandise, wherein the records include a digital identity in the form of the unique public key of the chip and a value that is associated with that public key in the form of the third-party application identifier (e.g. a URL). As described in more detail herein, at the time of manufacture, the chips are registered with the system in the system registry. Thereafter, ownership of the chip may be established and transferred in a manner that maintains the binding of the chip in the system registry as described. As also described in more detail herein, the information that is maintained in the registry may be used to later verify the chip and the associated merchandise. In embodiments where the system employs a decentralized blockchain registry to implement the system registry and thus to store the above information, the system is a trustless system that is not bound to a specific organization. Accordingly, in such an embodiment, the system of the disclosed concept provides a global, trustlessly identifiable way of connecting a product to its digital identity.

Furthermore, as described herein, in the exemplary embodiment, the system may employ two different types of IC chips that may be embedded in the merchandise. Those exemplary chips include what are known as asymmetric signer (AS) chips and symmetric signer (SS) chips. The AS chips described herein include a built-in secure element that can perform cryptographic ECDSA signatures (e.g., Secp256k1), including the generation of unique private-public key pairs. AS chips thus employ a form of asymmetric encryption and can act as miniature wallets in that they can generate and store private-public key pairs (e.g., blockchain-native private-public key pairs). In an exemplary embodiment, the AS chips described herein may be type-4 NFC ICs with a built-in secure element as described herein. SS chips, on the other hand, do not have the same type of built in secure element and thus do not have the ability to generate such private-public key pairs. Instead, SS chips have the capability of using symmetric encryption, such as AES symmetric encryption, and are provided with built-in read counters. A drawback of such SS chips is that they do not support the kind of custom signing commands that AS chips are capable of, and are constrained to authentication through the use of various symmetric keys. As a result, as described herein, SS chips require a certain degree of centralized trust. In an exemplary embodiment, the SS chips as described herein may be NTAG 424 type-4 NFC chips.

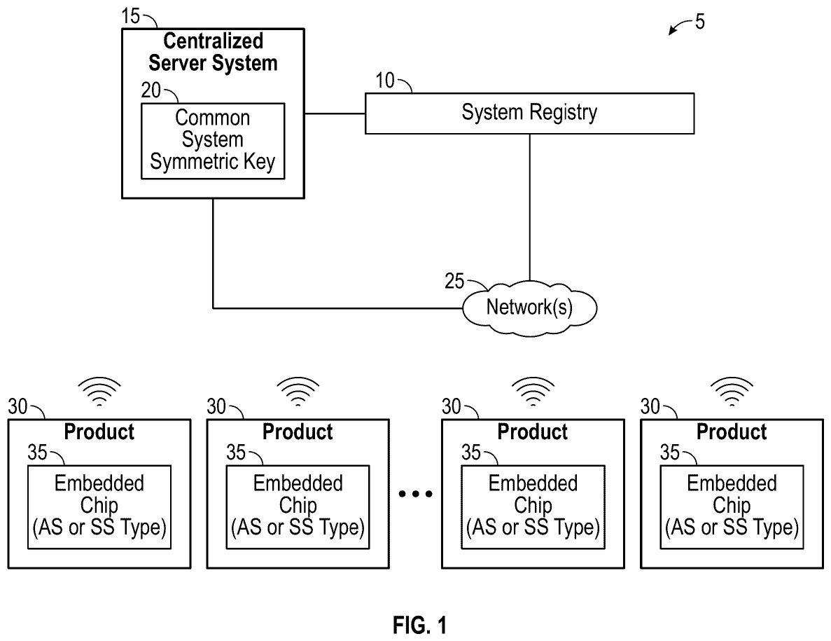

FIG. 1 is a schematic diagram of a system 5 according to a non-limiting exemplary embodiment of the disclosed concept. As seen in FIG. 1, system 5 includes a system registry 10 as described above, which may comprise a centralized server/database system, a decentralized blockchain registry, or a combination of the two. As noted above and as described in more detail below, system registry 10 is structured and configured to store certain information for binding products and embedded chips to associated third-party applications. System 5 further includes a centralized server system 15 that is structured and configured to store in a centralized manner certain information comprising a common system symmetric (secret) key 20 described herein that is required for implementation of the disclosed concept in connection with SS type chips. System 5 also includes network(s) 25 comprising a number of wired and/or wireless communications networks including, for example, the Internet. Network(s) 25 enables the transfer of information among the various components of system 5 that is required for effective implementation of the disclosed concept. System 5 also includes a plurality of products 30 each having an embedded chip 35 (AS or SS type in the exemplary implementation). Each product 30 and each embedded chip 35 is registered as part of system 5 in the manner described herein in order to enable each product 30 and embedded chip 35 to be bound to an associated third-party application by way of a unique digital identity, comprising a unique public key in the exemplary embodiment. The particulars of the registration process for both types of chips are described in detail herein. In addition, the manner in which products 30 and embedded chips 35 may be claimed for ownership and thereafter transferred is also described in detail herein. Also, the manner in which each product 30 and embedded chip 35 may be validated in accordance with the disclosed concept is described in detail herein.

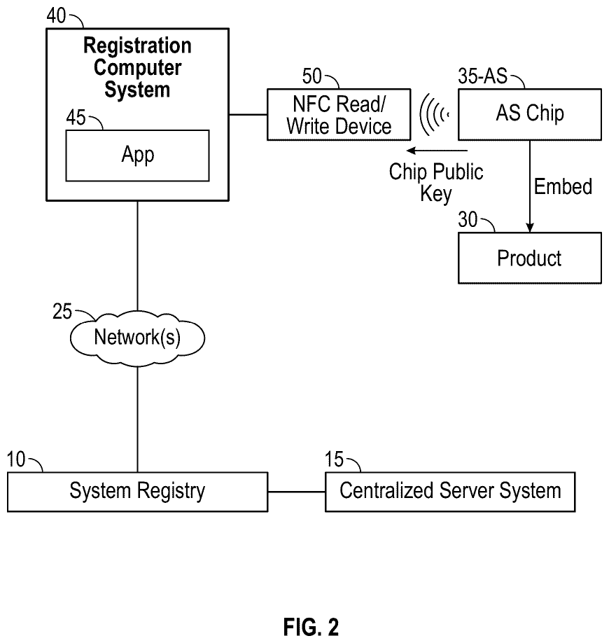

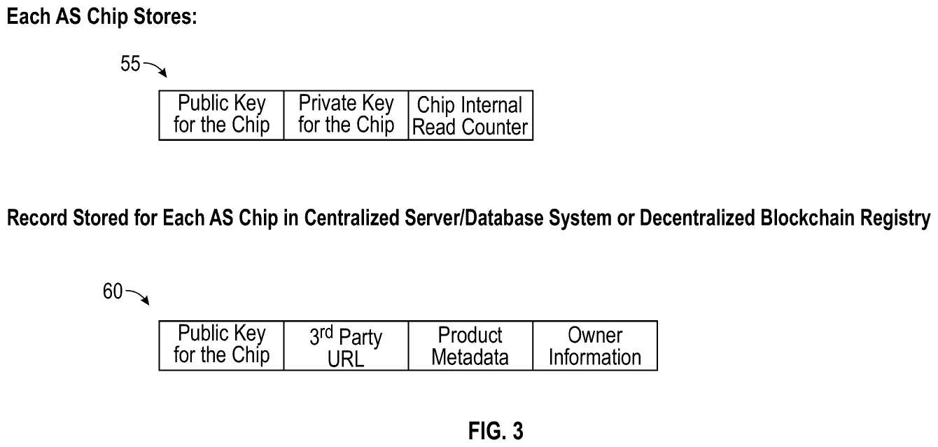

FIG. 2 is a schematic diagram which illustrates the registration process for AS chips in system 5 according to an exemplary embodiment of the disclosed concept. In the illustrated exemplary embodiment, AS chips are NFC chips and are registered at the time of manufacture by the product manufacturer or a third party that administers system 5. As seen in FIG. 2, the registration process employs a registration computer system 40, which in the exemplary embodiment is a normal backend server system, which implements a software application 45 structured and configured for performing the registration process as described herein. Registration computer system 40 is coupled to network 25 in order to enable it to communicate information to system registry 10 as described elsewhere herein. In addition, the registration process employs an NFC read/write device 50 that is coupled to registration computer system 40 for receiving information from an AS chip 35 that is to be embedded in a product 30. FIG. 3 is a schematic diagram which illustrates the information that is stored in each AS chip 35 and which is stored as a record in system registry 10 during the registration process in the manner described herein.

In operation, when AS chip 35 is to be registered, it is scanned by NFC read/write device 50 under control of registration computer system 40. This scan causes the secure element of AS chip 35 to generate a private-public key pair that is unique to A chip 35. As shown in FIG. 3, the private-public key pair is securely stored as part of a data element 55 on AS chip 35. Data element 55 further includes the value of the chip internal read counter of AS chip 35, which will be updated as appropriate on each read. At this point, AS chip 35 is embedded into product 30 and once registration is completed, product 30 is ready for sale. In addition, as shown in FIG. 2, at this point the newly generated chip public key is wirelessly communicated from AS chip 35 to NFC read/write device 50, which then provides the chip public key to registration computer system 40. Thereafter, registration computer system 40 creates a record 60 as shown in FIG. 3 that is communicated through network(s) 25 to system registry 10 for storage therein/thereby (either as part of a centralized server/database system and/or a decentralized blockchain registry depending on how system 5 is specifically implemented). As seen in FIG. 3, record 60 includes: (i) the public key for the chip, (ii) the identifier of the third-party application that is to be associated with (i.e. mapped to) that public key in system registry 10, which in the exemplary embodiment is a non-public URL as described herein, (iii) certain product metadata for product 30, including, for example, the type of product and the brand of the product, and (iv) owner information for AS chip 35 and product 30 being registered. Initially, at registration, the owner information portion of record 60 is provided with a “no owner” identifier, such as a value of zero, since product 30 has not yet been claimed for ownership according to an aspect of the disclosed concept described herein. At this point, registration of product 30 and embedded AS chip 35 is complete and product 30 and AS chip 35 are registered in system 5. In addition, in the exemplary embodiment, chips that are registered as just described are configured in a “locked” state wherein the ownership information for the chips cannot be changed unless and until it is first “unlocked” by system 5 as described herein.

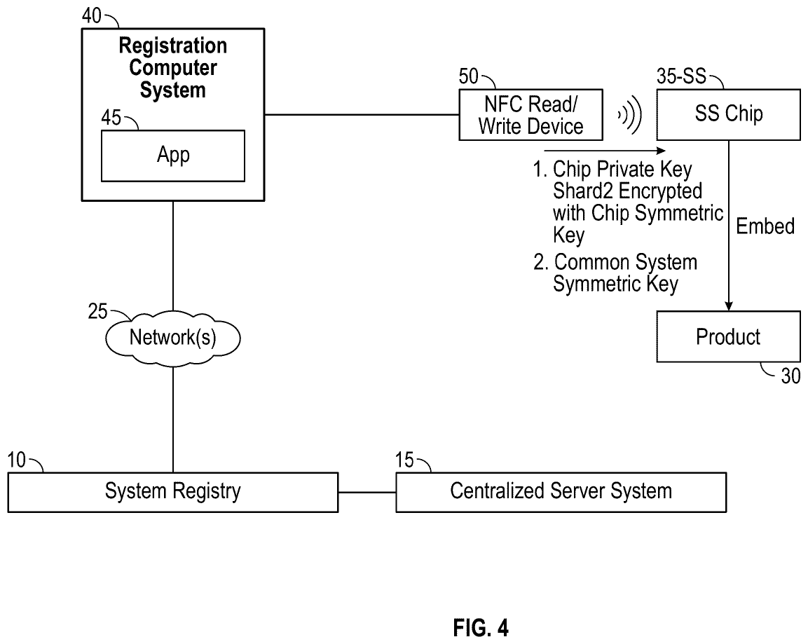

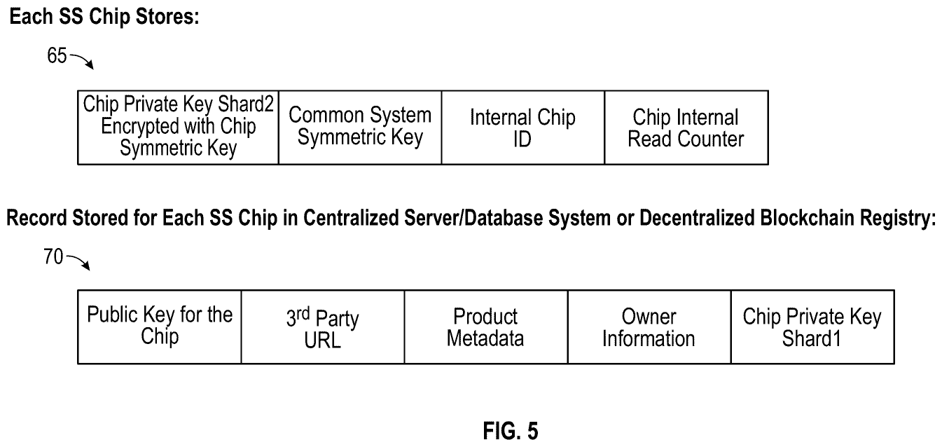

FIG. 4 is a schematic diagram which illustrates the registration process for SS chips in system 5 according to an exemplary embodiment of the disclosed concept. In the illustrated exemplary embodiment, SS chips are NFC chips and are registered at the time of manufacture by the product manufacturer or a third party that administers system 5. The registration process employs the same registration computer system 40 and NFC read/write device 50 as shown in FIG. 2. FIG. 5 is a schematic diagram which illustrates the information that is stored in each SS chip 35 and which is stored as a record in system registry 10 during the registration process in the manner described herein. As noted elsewhere herein, SS chips are different than AS chips and are not able to generate private-public key pairs. Thus, the registration process and the type of information that is generated and stored is different than that described for AS chips. Thus, in this embodiment, application 45 includes additional functionality described below that is required for registration of SS chips.

In operation, when SS chip 35 is to be registered, registration computer system 40, and specifically application 45, generates a unique private-public key pair for SS chip 35. Again, this is required because SS chip 35 does not have the secure element that AS chips have and thus does not have the capability to create such a private-public key pair. Next, registration computer system 40 and specifically application 45 creates two chip private key shards from the generated private key using a key sharding process such as a Multi-Party Computation (MPC) technology key sharding process. Those two shards are referred to herein as chip private key shard1 (or simply shard1) and the chip private key shard2 (or simply shard2). While in the exemplary embodiment two chip private key shards are created, that is not meant to be limning, and in other embodiments more than two shards may also be created. The purpose and function of the shards will be described in detail elsewhere herein and are utilized to validate an SS chip 35 once registered. In addition, as also noted elsewhere herein, centralized server system 15 of system 5 stores a common system symmetric (secret) key 20. Again, this symmetric secret key is used in the validation process as described elsewhere herein.

After generation of the private-public key pair and the two private key shards for SS chip 35 as just described, the chip private key shard2 is encrypted with the chip symmetric key 20, and that encrypted information along with the common system symmetric key 20 is written onto SS chip 35 using NFC read/write device 50 as part of a data element 65 securely stored on SS ship 65 as shown in FIG. 5. Data element 65 further includes the internal chip ID for SS chip 35 and the value of the chip internal read counter of SS chip 35, which will be updated as appropriate on each read. At this point, SS chip 35 is embedded into product 30 and once registration is completed, product 30 is ready for sale. At this point, registration computer system 40 creates a record 70 as shown in FIG. 5 that is communicated through network(s) 25 to system registry 10 for storage therein/thereby (either as part of a centralized server/database system and/or a decentralized blockchain registry depending on how system 5 is specifically implemented). As seen in FIG. 5, record 70 includes: (i) the public key for the chip, (ii) the identifier of the third-party application that is to be associated with (i.e. mapped to) that public key in system registry 10, which in the exemplary embodiment is a non-public URL as described herein, (iii) certain product metadata for product 30, including, for example, the type of product and the brand of the product, (iv) owner information for AS chip 35 and product 30 being registered, and (v) the chip private key shard1. Initially, as is the case for AS chips, at registration, the owner information portion of record 70 is provided with a “no owner” identifier, such as a value of zero, since product 30 has not yet been claimed according to an aspect of the disclosed concept described herein. At this point, registration of product 30 and embedded SS chip 35 is complete and product 30 and embedded SS chip 35 are registered in system 5. In addition, in the exemplary embodiment, chips that are registered as just described are configured in a “locked” state wherein the ownership information for the chips cannot be changed unless and until it is first “unlocked” by system 5 as described herein.

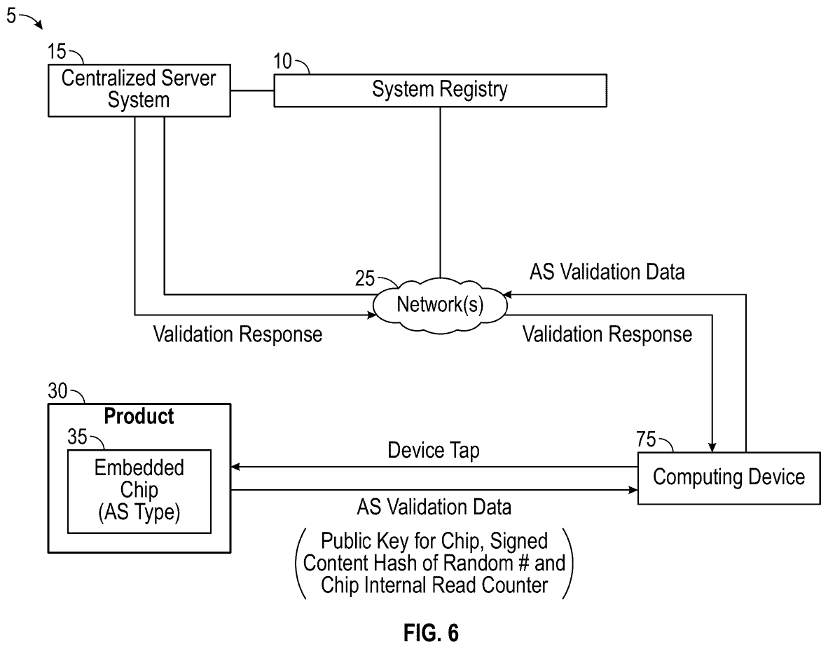

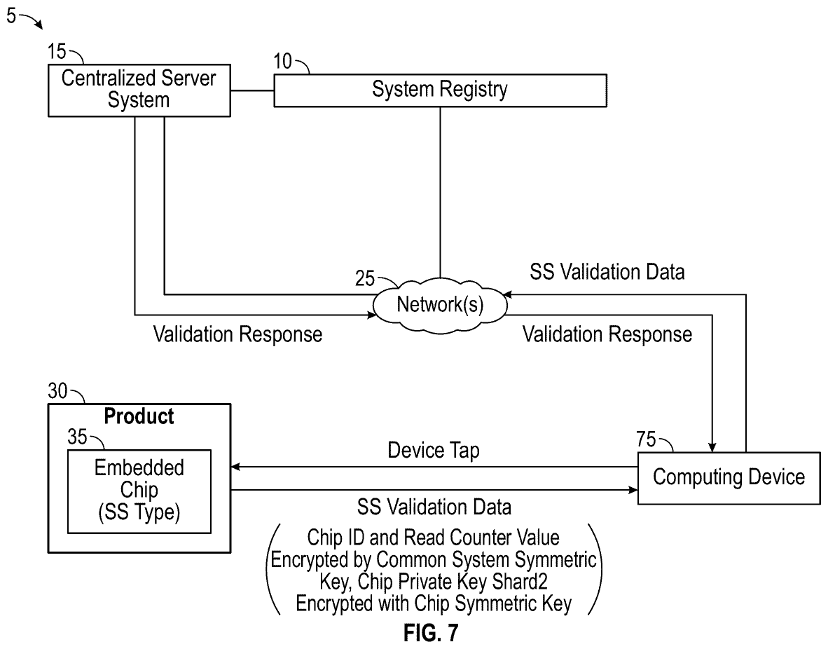

Next, the process for validating a product 30 and embedded chip 35 will be described. The validation process is different, depending on whether the embedded chip 35 is an AS type chip or an SS type chip. Each of these validation processes is described below, with reference to FIG. 6 for validation of AS type chips and FIG. 7 for validation of SS type chips.

Referring to FIG. 6, validation of an AS type embedded chip 35 begins with a computing device 75, such as, without limitation, a smartphone or tablet computer, performing and NFC device tap of the embedded chip 35. In response, embedded chip 35 will return certain AS validation data to computing device 75. As shown in FIG. 6, in the exemplary embodiment, the AS validation data includes the public key for embedded chip 35 and a signed content hash of a random number generated by embedded chip 35 and the internal read counter of embedded chip 35. The signed content hash is signed using the private key of embedded chip 35. The AS validation data is provided to centralized server 15 so that centralized server 15 can determine whether embedded chip 35 should be validated. Specifically, centralized server 15 will obtain the public key for embedded chip 35 from system registry 10 and will determine whether or not the signed content hash can be validated using the chip public key and the random number and read counter value. If embedded chip 35 is able to be validated in this manner, centralized server system 15 will obtain the third-party app identifier (e.g. URL) that is associated with and bound to the public key of embedded chip 35 from system registry 10 and will send that information back to computing device 75 as part of a validation response. If, however, the signed content hash is not able to be validated, centralized server 15 will return an error message as the validation response. In the case where embedded chip 35 is able to be validated, the user of computing device 75 will be able to access the associated third-party application using the received the third-party app identifier.

Referring to FIG. 7, validation of an SS type embedded chip 35 also begins with a computing device 75, such as, without limitation, a smartphone or tablet computer, performing and NFC device tap of the embedded chip 35. In response, embedded chip 35 will return certain SS validation data to computing device 75. As shown in FIG. 7, in the exemplary embodiment, the SS validation data includes: (i) the chip ID and read counter value of embedded chip 35 encrypted by the common system symmetric key 20 (FIG. 1), and (ii) the chip private key shard2 encrypted with the symmetric key of embedded chip 35. The SS validation data is provided to centralized server 15 so that centralized server 15 can determine whether embedded chip 35 should be validated. Specifically, centralized server 15 will decrypt the encrypted chip ID and read counter value using the common system symmetric key 20, will use the chip ID to obtain the chip private key shard 14 chip 35 from system registry 10, use the chip symmetric key to decrypt the encrypted private key shard2, and will use MPC procedures to generate the chip private key from the decrypted chip private key shard2 and the chip private key shard1 obtained from system registry 10. At this point, centralized server 15 has both the chip private key and the chip public key, and is able to use those two keys to validate chip 35. Specifically, in the exemplary embodiment, centralized server 15 will generate a random number, encrypted with the chip public key and then decrypt it with the chip private key to determine whether the two keys are part of the same private-public key pair. If this validation process is successful, centralized server system 15 will obtain the third-party app identifier (e.g. URL) that is associated with and bound to the public key of embedded chip 35 from the system registry 10 and will send that information back to computing device 75 as part of a validation response. If, however, this validation process is not successful, centralized server 15 will return an error message as the validation response. Again, in the case where embedded chip 35 is able to be validated, the user of computing device 75 will be able to access the associated third-party application using the received the third-party app identifier.

A further aspect of the disclosed concept involves unlocking native mechanisms for transferability and as a result trading of the physical assets, namely products 30 having embedded chips 35. As described in connection with FIGS. 2-4, the disclosed concept employs a registration process through which microchipped physical merchandise comprising products 30 having embedded chips 35 will have their “identity” registered on system registry 10. In implementations employing a decentralized blockchain registry for system registry 10, this process creates “trustless digital identities” for physical objects. What will now be described is the notion of digital ownership of these registered assets.

As explained above, system registry 10 has the notion of an “owner” (see product metadata in FIGS. 3 and 5). For example, in the case where Ethereum (a decentralized blockchain with smart contract functionality) is used for system registry 10, each owner is a cryptographic address tied to some owner externally owned account (EOA). In an aspect of the disclosed concept, every registrar entity in system 5 will also be provided with a native transferability mechanism, which works in the following manner in the exemplary embodiment. On registration, as noted elsewhere herein in the description of the registration process, the owner will be the zero address. On initial claim, an “authenticated” user will have a smart contract wallet address created on their behalf using their logged in identity (e.g., either through their Google account or an account of the administrator of system 5), and that smart contract wallet address will then become the owner. In the exemplary embodiment, such a claim involves a user clicking a native “claim” button built into a partner microsites that is tied to the embedded chip 35 in question.

In a further aspect of the disclosed concept, the registrar will establish and control polices on who may become such an authenticated user. Such policies will lie somewhere on a spectrum between the following two extremes: a non-restrictive policy and a restrictive policy. Each of these extremes is described below.

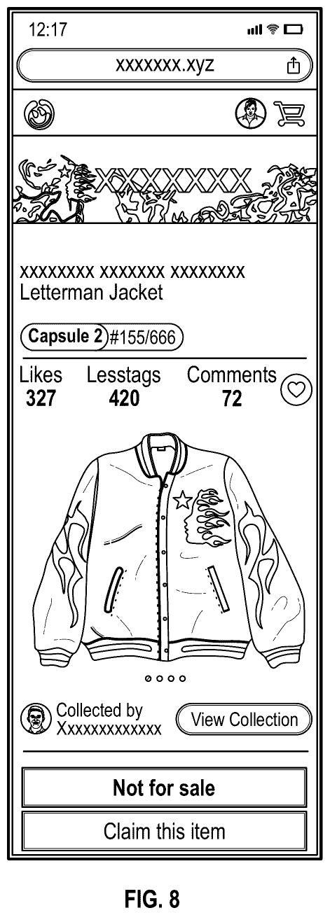

A non-restrictive policy is one in which “ANYONE” can claim ownership of a registered product 30 having an embedded chip 35, as long as they have physical possession of product 30. In this scenario, the only prerequisite to ownership is that the potential owner log in (e.g., using Google or administrator account credentials as described). From an application point of view, this may be done as shown on the exemplary webpage shown in FIG. 8, where clicking “Claim this item” does not result in any subsequent instructions, and instead causes the logged in user to instantly become the owner.

A restrictive policy, on the other hand, is one in which only “ALLOWLISTED” users can claim ownership of the item. In this model, the first registration of a chip 35 would also require the registrar (e.g., the brand or the administrator of system 5) to specify who is authorized to be the first claimant (i.e., whitelisted for claiming). This would be possible in cases of primary online or direct retail store sales (with administrator applications for controlling registration as described herein), whereby the brand-approved seller would be able to collect the buyer's information (e.g., email), and use that information to create an account, such as blockchain account, for the buyer that could then directly be used for whitelisting the initial claimant during registration. Then, if the newly authenticated user were to sell or transfer their item to someone else, only they, or some administrative brand entity, would be able to whitelist the new recipient. What is important to understand here is that on the protocol side, there will be two important entities used for transfer authorization, the owner and some sort of brand “administrator” that is configured on the brand registrar contract.

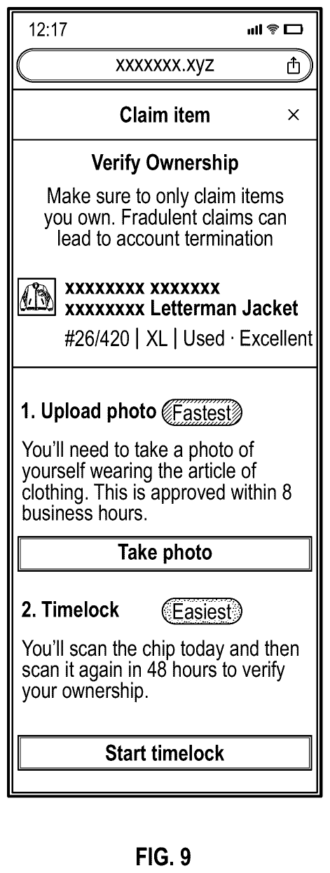

Now, in reality, the above two extremes serve as prime examples of the classic UX vs. security trade-off any application or protocol has to make. The first offers unlimited flexibility, where anyone with physical proximity to a chip 35 can claim it and become the owner. The drawback, of course, is security. For example, an owner would not want someone to be able to scan a chip 35 on their shirt (the product 30) while the owner is watching a movie and thereby become the owner of the product 30 and transact digitally with it. On the other hand, a restrictive policy, where every trade requires approval by either the current already authorized owner of the product 30 or some sort of brand-approved administrator may be too limiting. Thus, a further aspect of the disclosed concept provides a solution that is actually a balancing act between these two extremes, which in the exemplary embodiment will be natively supported by the protocol of the disclosed concept. Specifically, in this aspect of the disclosed concept there is a “time-lock” feature that is natively integrated into the protocol, whereby anyone who scans the same item twice with some minimum time interval in between (configured on the brand registrar) will be able to become the owner of the product 30 in question. This is illustrated in the exemplary webpage shown in FIG. 9. However, on top of this, an administrator can still override this process, and allow claims to be made using administrator capabilities. As shown in FIG. 9, one such method will be a photo-based verification where, if a photo verification passes, the brand application, by virtue of it being granted brand registrar “administrator” privileges, will be able to override the owner to be that of the prospective claimant. In summary, this part of the protocol of the disclosed concept encapsulates the idea that system 5 may store both native chip NFT owners and brand registrar administrators on the protocol side, and through this, using higher level abstractions built using applications which are granted administrator privileges, arbitrary trading and transfer functionality can be built.

Next, two important constituent elements of the disclosed concept, ownership and transfers, will be described in greater detail. These elements are what allows the disclosed concept to build meaningful, customizable applications, such as marketplaces or social applications, on top of system 5 as described herein. The above description focused on how these primitives work on the protocol side, and below a detailed description is provided of how they work on the application side.

With respect to the products 30 of the disclosed concept, the notion of ownership expands into two forms: (i) the physical owner of the chip 35, and (ii) the digital owner of the chip 35 (i.e., the account or entity which “owns” the chip 35 on system registry 10). This is required since there needs to be a way for on-chain or online applications to understand who owns what piece of merchandise. This is solved in the disclosed concept by representing the “digital” versions of the chips 35 registered on the system registry 10 as “physical NFTs” that are “minted” upon registration and have their ownership “transferred” to the merchandise owner when they perform a “claim”. A claim involves a user scanning the chip 35, being redirected to the targeted brand application (based on the product metadata as described herein), and, in the exemplary embodiment, clicking a button that authenticates the user. System 5 then performs a protocol-wide transfer that makes the authenticated user the owner of the chip 35 on system registry 10.

Prior to ever getting their hands on merchandise (i.e., products 30), consumers have essentially the following strategies for obtaining merchandise (i.e., products 30): (i) through an online order, where the administrator of system 5 may or may not be involved with the ordering process, or (ii) through a real-world (e.g., brick and mortar) retail order, where the administrator of system 5 may or may not be involved with the purchasing process. The details of what happens for a claim in system 5 in each of these scenarios are described below.

For an online order, if the administrator of system 5 is involved, they can collect user information, such as email address or phone number, to facilitate user authorization of a claim later on. Also, if the administrator of system 5 is involved with the ordering process, brands may choose a restrictive policy to perform only “whitelisted” claims (explained elsewhere herein). Otherwise, the brands may only choose (i) the hybrid claim methodology (where users can become owner either through the time-lock process as described or through some application approved vetting scheme such as photo verification), or (ii) the trustless non-restrictive model where “anyone” can claim ownership.

For a real-world retail order, if the administrator of system 5 is not involved with the purchasing process (i.e., the administrator of system 5 grants the brand reseller/merchant an administrative application that has “admin” privileges for whitelisting users via the protocol), then brands can select to perform “whitelisted” claims post-sale in-store. Otherwise, again, the brand can choose either the hybrid claim methodology or the “anyone-can-claim” model.

On the protocol side, this means that “digital owners” will not be materialized on system registry 10 until either a time-lock-based claim is actuated or a brand registrar approved alternative admin verification process successfully occurs. However, from a UI/UX standpoint, the user will notice minimal friction. If claiming through a time-lock, this simply means that on first claim, the user will still see all the details of their product with themselves as the owner. Thereafter, a minimally invasive UI indicator will be present indicating that the claim is still in process (and will remain until the user finalizes the time-lock with a second claim). On the other hand, for any other approval processes, the same will apply, except no subsequent actions will be needed from the user besides the initial claim.

In the exemplary embodiment, the time-lock based claiming mechanism operates as follows: First, if a user has yet to have a smart contract account associated with their application account (which again is, for example, either through a Google login or a login with the administrator of system 5), that will be created behind the scenes. As a result, behind every user of system 5 will be a custodial wallet used for their identity, and specifically a blockchain identity in cases where system registry 10 is implemented as a decentralized blockchain registry. Once that is done, the user will be prompted to scan chip 35. In the AS case, an EIP-712 signature attesting to the user wanting to “claim” the chip 35 is directly generated (the signature is basically a function whose inputs are the current timestamp, the internal chip ID of the chip 35 being claimed, and the function string “claim”). In the SS case, this is done indirectly, by first using NFC Data Exchange Format (NDEF) mirroring to fetch a signed URL which is used to decrypt the key and find the corresponding blockchain private key, and then use that private key to do the same as in the AS case. This will then be natively relayed to the protocol “claim” time-lock function, which will verify the signature is in fact of the chip 35, and derive from the signature the claimant address and the current timestamp. Then, on the subsequent time-lock claim, the same process will be done, with the additional check that the new timestamp minus the old timestamp is greater than or equal to the configured time-lock period established by the brand (which will likely preset to around a few hours in the exemplary embodiment). On the other hand, for brand-admin-approved claims, once a scan is done, a similar signature will be generated, indicating a request by the owning address to unlock an item of merchandise. Once approved. an “admin” of the registrar will sign on top of the claimant signature, and pass that into another protocol “claim” function, which will then verify the transfer.

To accommodate future transfers and resells, the above process can be reshaped and tailored to the needs of each brand, depending on their security requirements. All of these processes are believed to unique to the combination of physical and blockchain technologies. In the exemplary embodiment, reselling works as follows. If a user wishes to sell their product 30, they may list it for sale on one of the brand applications (such as a branded marketplace app of the administrator of system 5). Once listed for sale, the digital chip ownership is transferred to a relayer, where it is locked, and the seller is given a shipment label for shipping directly to the buyer. Depending on the seller's reputation in the app, or based on the settings configured in the brand registrar (which, for example, may require the seller to post some amount of collateral), the seller will be redirected through additional authorization steps. On the buying side, if a listing is accepted by a buyer, the same set of pre-claim processes are then administered at the protocol level as described above. In the exemplary embodiment, the funds of the buyer are held in escrow by the administrator of system 5. Once the package is received, and the chip 35 is claimed, funds are transferred out of escrow to the seller. The claims themselves follow the same procedures as described elsewhere herein.

While particular exemplary embodiments for claiming and transferring ownership are described above, it will be understood that those embodiments are not meant to be limiting. Rather, claiming and transferring ownership may be based on a combination of any brand approval of photos, user metrics and time-locking.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A registration method for binding merchandise to a third-party application, comprising:
creating or receiving a unique digital identity for an integrated circuit (IC) chip, wherein the IC chip has wireless communication capability, wherein the unique digital identity is or will be stored in the IC chip and wherein the IC chip is or will be embedded as part of a physical product; and
causing information for the IC chip and the physical product to be created and communicated to a system registry for storage in the system registry, wherein the information includes: (i) the unique digital identity, (ii) an identifier of the third-party application, (iii) product metadata for the physical product, and (iv) owner information indicative of a current owner of the physical product.

2. The method according to claim 1, wherein the system registry is a centralized registry.

3. The method according to claim 1, wherein the system registry is a decentralized blockchain registry.

4. The method according to claim 1, wherein the unique digital identity is a public key of a private-public key pair of the IC chip.

5. The method according to claim 4, wherein the IC chip is an asymmetric signer (AS) chip having a secure element, and wherein the private-public key pair is generated and stored by the IC chip.

6. The method according to claim 5, wherein the public key is wirelessly transmitted from the IC chip to a registration computer system, and wherein the registration computer system causes the information to be created and communicated to the system registry.

7. The method according to claim 5, wherein the IC chip is a near field communication (NFC) chip.

8. The method according to claim 4, wherein the IC chip is a symmetric signer (SS) chip.

9. The method according to claim 8, wherein the private-public key pair is generated by a registration computer system, and wherein the registration computer system causes the information to be created and communicated to the system registry.

10. The method according to claim 9, further comprising generating in the registration computer system at least a first private key shard and a second private key shard from the private key of the private-public key pair and transmitting an encrypted version of the second private key shard to the IC chip for storage by the IC chip, wherein the encrypted version of the second private key shard is created using a first symmetric key that is unique to the IC chip, wherein the first private key shard is part of the information for the IC chip and the physical product.

11. The method according to claim 10, the method further comprising communicating a common system symmetric key to the IC chip for storage by the IC chip.

12. The method according to claim 8, wherein the IC chip is a near field communication (NFC) chip.

13. The method according to claim 1, wherein the identifier of the third-party application comprises a non-public uniform resource locator (URL) of the third-party application.

14. The method according to claim 1, wherein the product metadata comprises a type and/or brand of the physical product.

15. The method according to claim 1, wherein the owner information initially indicates that there is no current owner of the physical product.

16. The method according to claim 15, wherein the IC chip is initially in a locked configuration wherein the owner information in stored in the system registry cannot be changed unless and until it is first unlocked.

17. A system for binding merchandise to a third-party application, comprising:
a registration computer system, wherein the registration computer system is structured and configured to:
create or receive a unique digital identity for an integrated circuit (IC) chip, wherein the IC chip has wireless communication capability, wherein the unique digital identity is or will be stored in the IC chip and wherein the IC chip is or will be embedded as part of a physical product; and
cause information for the IC chip and the physical product to be created and communicated to a system registry for storage in the system registry, wherein the information includes: (i) the unique digital identity, (ii) an identifier of the third-party application, (iii) product metadata for the physical product, and (iv) owner information indicative of a current owner of the physical product.

18. The system according to claim 17, wherein the system registry is a centralized registry.

19. The system according to claim 17, wherein the system registry is a decentralized blockchain registry.

20. The system according to claim 17, wherein the unique digital identity is a public key of a private-public key pair of the IC chip.

21. The system according to claim 20, wherein the IC chip is an asymmetric signer (AS) chip having a secure element, and wherein the private-public key pair is generated and stored by the IC chip.

22. The system according to claim 21, wherein the public key is wirelessly transmitted from the IC chip to the registration computer system.

23. The system according to claim 21, wherein the IC chip is a near field communication (NFC) chip, and wherein the system further comprises an NFC reader device for reading the IC chip.

24. The system according to claim 20, wherein the IC chip is a symmetric signer (SS) chip.

25. The system according to claim 24, wherein the registration computer system is structured and configured to generate the private-public key pair.

26. The system according to claim 25, wherein the registration computer system is structured and configured to generate at least a first private key shard and a second private key shard from the private key of the private-public key pair and communicate an encrypted version of the second private key shard to the IC chip for storage by the IC chip, wherein the encrypted version of the second private key shard is created using a first symmetric key that is unique to the IC chip, and wherein the first private key shard is part of the information for the IC chip and the physical product.

27. The system according to claim 26, further comprising communicating a common system symmetric key to the IC chip for storage by the IC chip.

28. The system according to claim 24, wherein the IC chip is a near field communication (NFC) chip.

29. The system according to claim 17, wherein the identifier of the third-party application comprises a non-public uniform resource locator (URL) of the third-party application.

30. The system according to claim 17, wherein the product metadata comprises a type and/or brand of the physical product.

31. The system according to claim 17, wherein the owner information initially indicates that there is no current owner of the physical product.

32. A method of validating an integrated circuit (IC) chip embedded as part of a physical product, wherein the IC chip and the physical product are bound to a third-party application in a system registry, wherein the system registry stores information for the IC chip that includes a unique digital identity for the IC chip and an identifier of the third-party application, the method comprising:
receiving validation data generated by the IC chip from a computing device, wherein the validation data includes first information associated with the unique digital identity;
receiving second information associated with the unique digital identity;
determining whether the IC chip can be validated based on the validation data and the second information associated with the unique digital identity; and
responsive to determining that the IC chip can be validated, communicating the identifier of the third-party application to the computing device.

33. The method according to claim 32, further comprising obtaining the identifier of the third-party application from the system registry responsive to determining that the IC chip can be validated.

34. The method according to claim 32, wherein the system registry is a centralized registry.

35. The method according to claim 32, wherein the system registry is a decentralized blockchain registry.

36. The method according to claim 32, wherein the unique digital identity is a public key of a private-public key pair of the IC chip, wherein the first information associated with the unique digital identity is generated using the private key of the IC chip, and wherein the second information associated with the unique digital identity is the public key of the IC chip.

37. The method according to claim 36, wherein the first information associated with the unique digital identity is a signed content hash generated using the private key of the IC chip.

38. The method according to claim 36, wherein signed content hash is generated using a random number generated by the IC chip, a value of an internal read counter of the IC chip, and the private key of the IC chip.

39. The method according to claim 38, wherein the validation data also includes the public key of the IC chip.

40. The method according to claim 32, wherein the second information associated with the unique digital identity includes the public key of the IC chip and a first private key shard generated based on the private key of the IC chip, wherein the unique digital identity is a public key of a private-public key pair of the IC chip, wherein the first information associated with the unique digital identity comprises an encrypted version of a second private key shard, wherein the second private key shard is generated based on the private key of the IC chip, and wherein the encrypted version of the second private key shard is generated using a symmetric key unique to the IC chip.

41. The method according to claim 40, wherein the determining whether the IC chip can be validated includes obtaining the second private key shard from the encrypted version of the second private key shard using the symmetric key unique to the IC chip, using the first private key shard and the second private key shard to obtain the private key of the IC chip, and using the private key and the public key of the IC chip to determine whether the IC chip can be validated.

42. The method according to claim 40, wherein the validation data also includes an encrypted version of a chip ID for the IC chip and a value of an internal read counter of the IC chip generated using a common symmetric key stored by the IC chip.

43. The method according to claim 32, wherein the identifier of the third-party application comprises a non-public uniform resource locator (URL) of the third-party application.

44. The method according to claim 32, wherein the information for the IC chip stored by the system registry further includes product metadata the physical product that comprises a type and/or brand of the physical product.

45. The method according to claim 32, wherein the information for the IC chip stored by the system registry further includes owner information indicative of a current owner of the physical product.

46. The method according to claim 32, wherein the IC chip is a near field communication (NFC) chip and wherein the validation data is received in response to a device tap of the IC chip by the computing device.

47. A system for validating an integrated circuit (IC) chip embedded as part of a physical product, wherein the IC chip and the physical product are bound to a third-party application in a system registry, wherein the system registry stores information for the IC chip that includes a unique digital identity for the IC chip and an identifier of the third-party application, the system comprising:
a computer system, wherein the computer system is structured and configured to:
receive validation data generated by the IC chip from a computing device, wherein the validation data includes first information associated with the unique digital identity;
receive second information associated with the unique digital identity;
determine whether the IC chip can be validated based on the validation data and the second information associated with the unique digital identity; and
responsive to determining that the IC chip can be validated, communicate the identifier of the third-party application to the computing device.

48. The system according to claim 47, wherein the computer system is structured and configured to obtain the identifier of the third-party application from the system registry responsive to determining that the IC chip can be validated.

49. The system according to claim 47, wherein the system registry is a centralized registry.

50. The system according to claim 47, wherein the system registry is a decentralized blockchain registry.

51. The system according to claim 47, wherein the unique digital identity is a public key of a private-public key pair of the IC chip, wherein the first information associated with the unique digital identity is generated using the private key of the IC chip, and wherein the second information associated with the unique digital identity is the public key of the IC chip.

52. The system according to claim 51, wherein the first information associated with the unique digital identity is a signed content hash generated using the private key of the IC chip.

53. The system according to claim 51, wherein signed content hash is generated using a random number generated by the IC chip, a value of an internal read counter of the IC chip, and the private key of the IC chip.

54. The system according to claim 53, wherein the validation data also includes the public key of the IC chip.

55. The system according to claim 47, wherein the second information associated with the unique digital identity includes the public key of the IC chip and a first private key shard generated based on the private key of the IC chip, wherein the unique digital identity is a public key of a private-public key pair of the IC chip, wherein the first information associated with the unique digital identity comprises an encrypted version of a second private key shard, wherein the second private key shard is generated based on the private key of the IC chip, and wherein the encrypted version of the second private key shard is generated using a symmetric key unique to the IC chip.

56. The system according to claim 55, wherein the computer system is structured and configured to determine whether the IC chip can be validated by obtaining the second private key shard from the encrypted version of the second private key shard using the symmetric key unique to the IC chip, using the first private key shard and the second private key shard to obtain the private key of the IC chip, and using the private key and the public key of the IC chip to determine whether the IC chip can be validated.

57. The system according to claim 55, wherein the validation data also includes an encrypted version of a chip ID for the IC chip and a value of an internal read counter of the IC chip generated using a common symmetric key stored by the IC chip.

58. The system according to claim 47, wherein the identifier of the third-party application comprises a non-public uniform resource locator (URL) of the third-party application.

59. The system according to claim 47, wherein the information for the IC chip stored by the system registry further includes product metadata the physical product that comprises a type and/or brand of the physical product.

60. The system according to claim 47, wherein the information for the IC chip stored by the system registry further includes owner information indicative of a current owner of the physical product.

61. The system according to claim 47, wherein the IC chip is a near field communication (NFC) chip and wherein the validation data is received in response to a device tap of the IC chip by the computing device.

62. A method of controlling digital ownership of a physical product and an integrated circuit (IC) chip embedded as part of the physical product, wherein the IC chip and the physical product are bound to a third-party application in a system registry, wherein the system registry stores information for the IC chip that includes a unique digital identity for the IC chip, an identifier of the third-party application, and owner information indicative of a current owner of the IC chip and the physical product, the method comprising:
determining whether a user desiring to obtain ownership of the physical product and the IC chip can be authenticated based on user account credentials provided by the user;
receiving an ownership claim from the user for the physical product and the IC chip; and
responsive to the ownership claim and determining that the user can be authenticated, causing the owner information stored in the system registry to indicate that the user is the current owner of the IC chip and the physical product.

63. The method according to claim 62, wherein the user can be authenticated based on the user account credentials only if the user has been previously authorized to obtain ownership of the IC chip and the physical product.

64. The method according to claim 63, wherein the user may be previously authorized to obtain ownership of the IC chip and the physical product by either the current owner of the IC chip and the physical product at the time of the ownership claim or an administrator associated with a seller of the physical product or the third party of the third-party application.

65. The method according to claim 62, wherein the ownership claim is a first ownership claim received at a first time, the method further comprising:
receiving a second ownership claim from the user for the physical product and the IC chip at a second time; and
determining whether a difference between the first time and the second time is greater than or equal to a time threshold;
wherein the owner information stored in the system registry is caused to indicate that the user is the current owner of the IC chip and the physical product responsive to the ownership claim and determining that the user can be authenticated only if it is determined that the difference is greater than or equal to the time threshold.

66. The method according to claim 62, wherein the system registry is a centralized registry.

67. The method according to claim 62, wherein the system registry is a decentralized blockchain registry.

68. The method according to claim 67, wherein the user account credentials are based on a smart contract account of the user and comprise a blockchain identity for the user.

69. The method according to claim 62, wherein the unique digital identity is a public key of a private-public key pair of the IC chip.

70. The method according to claim 62, wherein the identifier of the third-party application comprises a non-public uniform resource locator (URL) of the third-party application.

71. A system for controlling digital ownership of a physical product and an integrated circuit (IC) chip embedded as part of the physical product, wherein the IC chip and the physical product are bound to a third-party application in a system registry, wherein the system registry stores information for the IC chip that includes a unique digital identity for the IC chip, an identifier of the third-party application, and owner information indicative of a current owner of the IC chip and the physical product, the system comprising:
a computer system, wherein the computer system is structured and configured to:
determine whether a user desiring to obtain ownership of the physical product and the IC chip can be authenticated based on user account credentials provided by the user;
receive an ownership claim from the user for the physical product and the IC chip; and
responsive to the ownership claim and determining that the user can be authenticated, cause the owner information stored in the system registry to indicate that the user is the current owner of the IC chip and the physical product.

72. The system according to claim 71, wherein the user can be authenticated based on the user account credentials only if the user has been previously authorized to obtain ownership of the IC chip and the physical product.

73. The system according to claim 72, wherein the user may be previously authorized to obtain ownership of the IC chip and the physical product by either the current owner of the IC chip and the physical product at the time of the ownership claim or an administrator associated with a seller of the physical product or the third party of the third-party application.

74. The system according to claim 72, wherein the ownership claim is a first ownership claim received at a first time, wherein the computer system is further structured and configured to:
receive a second ownership claim from the user for the physical product and the IC chip at a second time; and
determine whether a difference between the first time and the second time is greater than or equal to a time threshold;
wherein the owner information stored in the system registry is caused to indicate that the user is the current owner of the IC chip and the physical product responsive to the ownership claim and determining that the user can be authenticated only if it is determined that the difference is greater than or equal to the time threshold.

75. The system according to claim 72, wherein the system registry is a centralized registry.

76. The system according to claim 72, wherein the system registry is a decentralized blockchain registry.

77. The system according to claim 76, wherein the user account credentials are based on a smart contract account of the user and comprise a blockchain identity for the user.

78. The system according to claim 72, wherein the unique digital identity is a public key of a private-public key pair of the IC chip.

79. The system according to claim 72, wherein the identifier of the third-party application comprises a non-public uniform resource locator (URL) of the third-party application.
